(19) United States
(12) Patent Application Publication
(10) Pub. No.: US 2026/0194043 A1
(43) Pub. Date: Jul. 9, 2026

(54) CORNER CASTING PIN LOCK WITH A DETACHABLE LOCKING MEMBER

(71) Applicant: BNSF Logistics, LLC, Dallas, TX (US)

(72) Inventors: Alberto J. Alvarez, Coppell, TX (US); James W.V. Tabije, Coppell, TX (US); James Howard Jones, III, Plano, TX (US); Billy Ray Goodwin, Richland Hills, TX (US); Alejandra Soltero, Fort Worth, TX (US)

(73) Assignee: BNSF Logistics, LLC, Dallas, TX (US)

(21) Appl. No.: 19/012,586

(22) Filed: Jan. 7, 2025

(51) Int. Cl. F03D 13/40; B60P 7/08; B65D 85/68; B65D 90/00; F16B 41/00

(52) U.S. Cl. CPC F03D 13/401; B60P 7/08; B65D 85/68; B65D 90/0026; F16B 41/005; B65D 2585/6875; F05B 2260/02

(57) ABSTRACT

A corner casting pin locking system includes a corner casting having first and second side apertures and a corner casting insert having a pin lock aperture. The system further includes a corner casting pin lock that includes an engagement member, a handle, and a detachable locking member. The engagement member is configured to be inserted through the first side aperture of the corner casting and at least partially through the pin lock aperture of the corner casting insert. The handle is coupled to the engagement member and includes a locking member aperture. The detachable locking member is configured to be at least partially inserted into the locking member aperture. The detachable locking member includes a hook and a padlock aperture proximate an opposite end of the detachable locking member from the hook. The hook couples the detachable locking member to the corner casting through the second side aperture.

### TECHNICAL FIELD

This disclosure generally relates to corner castings such as those used for shipping containers, and more specifically to a corner casting pin lock with a detachable locking member.

### BACKGROUND

Corner castings are bulky metal structural objects that are used for securing large items such as shipping containers during transport. Corner castings are typically hollow, cube-shaped objects that have apertures on multiple sides that permit locking devices to be inserted into and operated within the corner casting. A typical locking device that is used to secure corner castings of objects such as shipping containers is a twist lock. Typical locking devices such as twist locks, while suitable for many applications, are not appropriate or effective for some transport applications involving corner castings.

### SUMMARY

The present disclosure achieves technical advantages as systems, devices, and methods for securing corner castings using a corner casting pin lock with a detachable locking member. In some embodiments, a corner casting pin locking system includes a corner casting having a first side aperture and a second side aperture. The corner casting pin locking system further includes a corner casting insert configured to be at least partially inserted into the corner casting. The corner casting insert includes a pin lock aperture. The corner casting pin locking system further includes a corner casting pin lock that includes an engagement member, a handle coupled to the engagement member, and a detachable locking member. The engagement member is configured to be inserted through the first side aperture of the corner casting and at least partially through the pin lock aperture of the corner casting insert. The handle includes a locking member aperture on a distal end of the handle opposite the engagement member. The detachable locking member is configured to be at least partially inserted into the locking member aperture of the handle. The detachable locking member includes a hook configured to couple the detachable locking member to the corner casting through the second side aperture of the corner casting. The detachable locking member further includes a padlock aperture proximate an opposite end of the detachable locking member from the hook.

In some embodiments, a wind turbine blade transport system includes a turbine blade fixture configured to secure one end of a turbine blade. The turbine blade fixture includes a corner casting having first side aperture and a second side aperture. The wind turbine blade transport system further includes a pedestal configured to removably couple to the turbine blade fixture. The pedestal includes a corner casting insert that is configured to be at least partially inserted into the corner casting of the turbine blade fixture as the turbine blade fixture is lowered onto the pedestal. The corner casting insert includes a pin lock aperture. The wind turbine blade transport system further includes a corner casting pin lock that includes an engagement member, a handle coupled to the engagement member, and a detachable locking member. The engagement member is configured to be inserted through the first side aperture of the corner casting and at least partially through the pin lock aperture of the corner casting insert. The handle includes a locking member aperture on a distal end of the handle opposite the engagement member. The detachable locking member is configured to be at least partially inserted into the locking member aperture of the handle. The detachable locking member includes a hook configured to couple the detachable locking member to the corner casting through the second side aperture. The detachable locking member further includes a padlock aperture proximate an opposite end of the detachable locking member from the hook.

In some embodiments, a corner casting pin lock includes an engagement member, a handle coupled to the engagement member, and a detachable locking member. The engagement member is configured to be inserted through a first side aperture of a corner casting and at least partially through a pin lock aperture of a corner casting insert. The handle includes a locking member aperture on a distal end of the handle opposite the engagement member. The detachable locking member is configured to be at least partially inserted into the locking member aperture of the handle. The detachable locking member includes a hook configured to couple the detachable locking member to the corner casting through a second side aperture. The detachable locking member further includes a padlock aperture proximate an opposite end of the detachable locking member from the hook.

Technical advantages of certain embodiments may include systems, devices, and methods for securing corner castings using a corner casting pin lock with a detachable locking member. In particular, the disclosed embodiments provide solutions to problems with securing corner castings on large, bulky items using typical locking devices such as twist locks. When transporting large, bulky items such as wind turbine blades via rail, ship, or land vehicles, the lateral and longitudinal forces exerted on locking devices such as twist locks may exceed maximum operating specification of the locking devices. Incomplete insertion of a twist lock into the corner casting may result due to misalignment of the fixture when loading onto the corner casting. Misalignment can lead to incomplete engagement of the twist lock with the corner casting. These may damage the locking devices, thereby resulting in safety hazards due to shifting and unsecured loads. Embodiments of the disclosure, however, provide a solution to these problems by providing corner casting pin locks that are easy to operate, are strong enough to handle large sheering loads that typical locking devices are unable to handle, and may be easily and visually verified as being locked by personnel. By providing corner casting pin locks according to embodiments of the disclosure, the shipping and transport operations of rail, ship, and ground vehicle shippers may be improved. As a result, the safety and reliability of shipping and transporting large, bulky items such as wind turbine blades can be increased.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present disclosure and its advantages, reference is now made to the following descriptions taken in conjunction with the accompanying drawings, in which:

FIGS. 1A and 1B are diagrams illustrating a wind turbine blade transport system utilizing a pin locking system, according to particular embodiments.

FIG. 2 is a diagram illustrating a corner casting pin lock with a detachable locking member that may be used by the pin locking system of FIG. 1, according to particular embodiments.

FIG. 3 is a diagram illustrating a corner casting insert, according to particular embodiments.

FIG. 4 is a diagram illustrating the installation of a corner casting pin lock with a detachable locking member onto a corner casting, according to particular embodiments.

FIG. 5 is a diagram illustrating a corner casting pin lock with a detachable locking member in a locking position, according to particular embodiments.

FIG. 6 is a diagram illustrating a storage position of a corner casting pin lock with a detachable locking member, according to particular embodiments.

FIG. 7 is a chart illustrating a method for securing a corner casting using a corner casting pin lock with a detachable locking member, according to particular embodiments.

FIGS. 8A and 8B are diagrams illustrating another corner casting pin lock with a detachable locking member that may be used by the pin locking system of FIG. 1, according to particular embodiments.

It should be understood that the drawings are not necessarily to scale and that the disclosed embodiments are sometimes illustrated diagrammatically and in partial views. In certain instances, details which are not necessary for an understanding of the disclosed methods and devices or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, as evidenced by issuance of this patent, the prior art fails to disclose or teach the elements and limitations presented in the claims as enabled by the specification and drawings, such that the presented claims are patentable under the applicable laws and rules of this jurisdiction.

Corner castings are bulky metal structural objects that are used for securing large items such as shipping containers during transport. Corner castings are typically hollow, cube-shaped objects that have apertures on multiple sides that permit locking devices to be inserted into and operated within the corner casting. A typical locking device that is used to secure corner castings of objects such as shipping containers is a twist lock. Typical locking devices such as twist locks, while suitable for many applications, are not appropriate or effective for some transport applications involving corner castings.

A particular application that utilizes corner castings is the transport of wind turbine blades on railcars. In these applications, both ends of a wind turbine blade may be attached to fixtures that have multiple corner castings. The fixtures may then be secured to the railcars (e.g., using pedestals). Typically, the corner castings may be secured to the pedestals using twist locks that are commonly used in the shipping industry to secure containers. Twist locks, however, have internal spring mechanisms that may be damaged by lateral and longitudinal forces during transport on the railcars, thereby increasing the risk of failure of the twist locks and ultimately increasing the risk of an accident or a derailment.

To address these and other problems with securing corner castings in certain applications such as railroad transport of wind turbine blades, the disclosed embodiments provide various corner casting pin locking systems and devices that may be utilized in transport applications where twist locks are unacceptable and risky. For example, a particular corner casting pin locking system includes a corner casting having first and second side apertures and a corner casting insert having a pin lock aperture. The corner casting insert is configured to be at least partially inserted into the corner casting. The corner casting pin locking system further includes a corner casting pin lock that includes an engagement member, a handle coupled to the engagement member, and a detachable locking member. The engagement member is configured to be inserted through the first side aperture of the corner casting and at least partially through the pin lock aperture of the corner casting insert. The handle is coupled to the engagement member and includes a locking member aperture on a distal end of the handle opposite the engagement member. The detachable locking member is configured to be at least partially inserted into the locking member aperture of the handle. The detachable locking member includes a hook and a padlock aperture. The hook is configured to couple the detachable locking member to the corner casting through the second side aperture. The padlock aperture is proximate an opposite end of the detachable locking member from the hook. The handle may be padlocked to the detachable locking member using the padlock aperture of the detachable locking member, thereby preventing the corner casting pin lock from becoming dislodged during transport and providing an easy visual indication to personnel that the corner casting pin lock is secured. Furthermore, unlike twist locks that are typically used to secure corner castings, the corner casting pin lock of the disclosed embodiments is formed from a solid durable metal (e.g., steel) that is able to withstand lateral and longitudinal forces during transport without being damaged or sheered. As a result, the transport of items such as wind turbine blades may be more secure, and accidents such as derailment may be avoided.

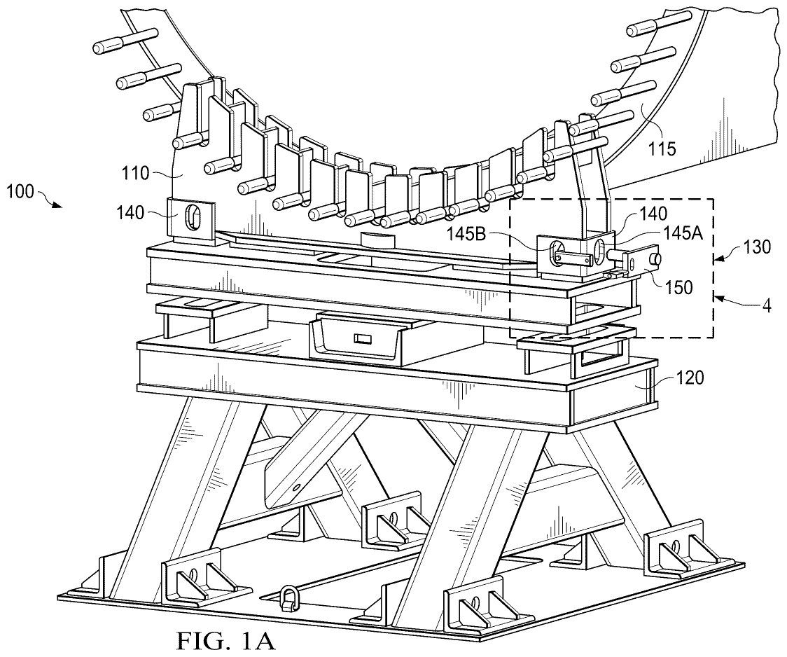

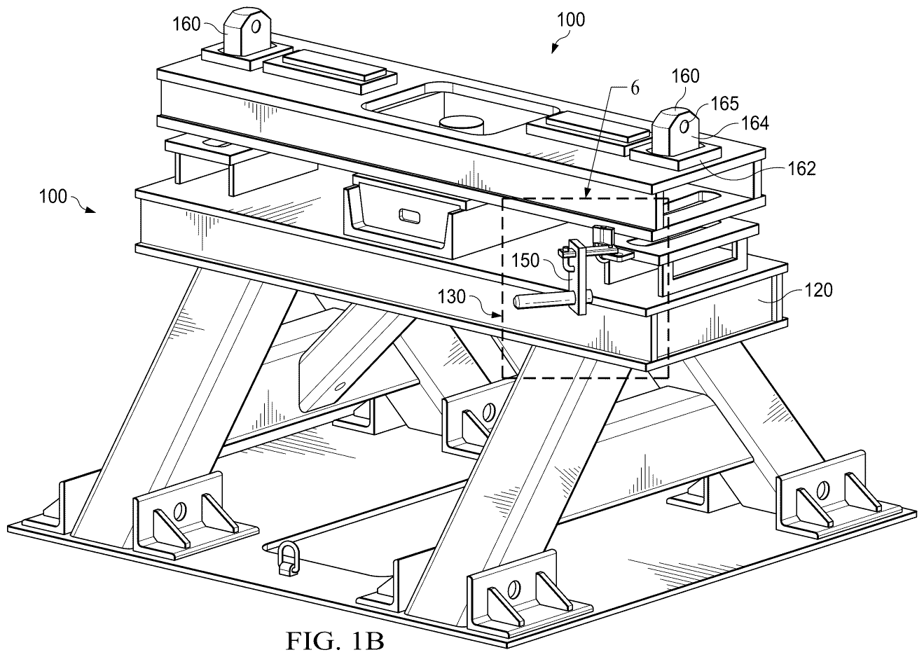

FIGS. 1A and 1B are diagrams illustrating a wind turbine blade transport system 100, according to particular embodiments. Wind turbine blade transport system 100 includes a wind turbine blade fixture 110, a pedestal 120, and a pin locking system 130. Wind turbine blade fixture 110 may be coupled to one end of a wind turbine blade 115. Wind turbine blade fixture 110 includes one or more corner castings 140 that are configured to be removably coupled to one or more corner casting inserts 160 that are attached to pedestal 120. Once corner castings 140 are lowered onto corner casting inserts 160 of pedestal 120, one or more corner casting pin locks 150 may be utilized to lock wind turbine blade fixture 110 to pedestal 120 during transport, as described in more detail below.

In general, wind turbine blade transport system 100 provides for the effective and efficient transport of wind turbine blade 115. Wind turbine blade transport system 100 may be used to transport wind turbine blade 115 via any appropriate transportation system (e.g., railway, ship, ground vehicle, etc.). To do so, each end of wind turbine blade 115 is removably attached to a wind turbine blade fixture 110. Each wind turbine blade fixture 110 includes one or more corner castings 140 (e.g., two corner castings 140 per wind turbine blade fixture 110, as illustrated). A pedestal 120 is installed on the transportation vehicle (e.g., railcar) at each end of wind turbine blade 115. Each pedestal 120 includes a corner casting insert 160 that aligns with each corner casting 140 of wind turbine blade fixture 110 (e.g., two corner casting inserts 160 per pedestal 120, as illustrated). Once wind turbine blade fixture 110 has been attached to wind turbine blade 115, wind turbine blade fixture 110 is lowered onto pedestal 120 such that each corner casting insert 160 is at least partially within its respective corner casting 140. Alternatively, wind turbine blade fixture 110 may be installed onto pedestal 120 first and then wind turbine blade 115 may be attached to wind turbine blade 115.

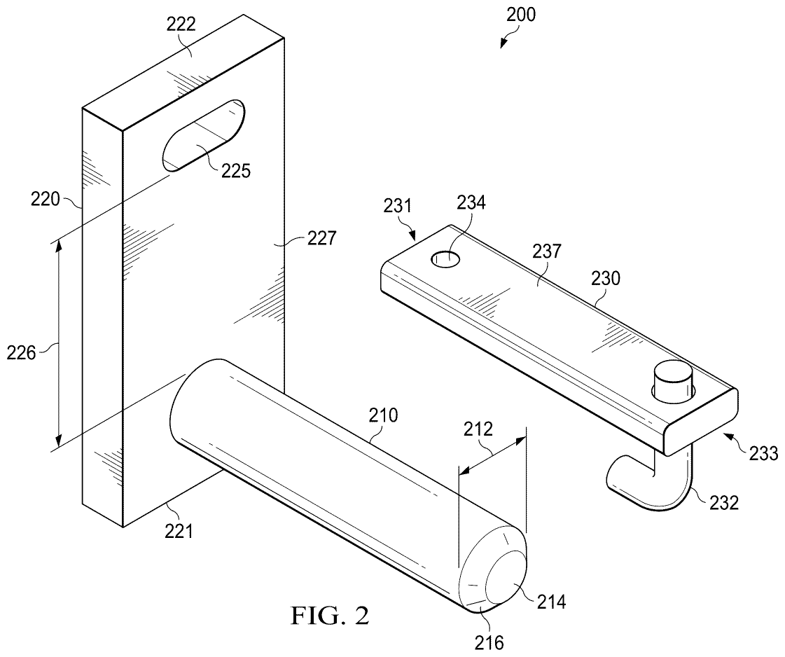

Once wind turbine blade fixture 110 has been installed onto pedestal 120, corner casting pin locks 150 are used to secure corner castings 140 to corner casting inserts 160 (and thereby secure wind turbine blade fixture 110 to pedestal 120). A particular embodiment of corner casting pin lock 150 is illustrated and described below in reference to corner casting pin lock 200 illustrated in FIG. 2. Specifically, an engagement member (e.g., engagement member 210) of a corner casting pin lock 150 is inserted through a first side aperture 145A of corner casting 140 and into pin lock aperture 165 of corner casting insert 160. One end of a detachable locking member of corner casting pin lock 150 (e.g., detachable locking member 230) may then be coupled to a second side aperture 145B of corner casting 140 (e.g., using a member such as hook 232). An opposite end of the detachable locking member may be inserted through an aperture of the handle (e.g., locking member aperture 225). The end of the detachable locking member that is inserted through the handle includes a padlock aperture (e.g., padlock aperture 234). A padlock 180 may then be installed through the padlock aperture of the detachable locking member in order to prevent corner casting pin lock 150 from being removed or becoming dislodged during transport. As a result, wind turbine blade fixture 110 may be securely and efficiently locked to pedestal 120, thereby ensuring the safe transport of wind turbine blade 115.

Wind turbine blade fixture 110 is any appropriate apparatus, device, or system that is configured to secure one end of wind turbine blade 115. In general, each end of wind turbine blade 115 is removably attached to a wind turbine blade fixture 110 using any appropriate fasteners or mechanism. For example, as illustrated in FIG. 1A, wind turbine blade fixture 110 may contain multiple slots or apertures that align with bolts that are installed on wind turbine blade 115. Wind turbine blade fixture 110 includes at least one corner casting 140 that is installed on or otherwise attached to a lower corner or edge of wind turbine blade fixture 110, as illustrated. In some embodiments, for example, wind turbine blade fixture 110 includes two corner castings 140 on opposite ends of wind turbine blade fixture 110. In other embodiments, however, wind turbine blade fixture 110 may have more than two corner castings 140 as needed.

Pedestal 120 is a device that is configured to removably couple to wind turbine blade fixture 110 using corner casting inserts 160. In some embodiments, pedestal 120 is a sawhorse-shaped device as illustrated and is used to elevate an end of wind turbine blade 115 to a proper height for transport. Each pedestal 120 includes at least one corner casting insert 160 that aligns with corner casting 140 of wind turbine blade fixture 110. In some embodiments, for example, pedestal 120 includes two corner casting inserts 160 coupled to a top, flat surface of pedestal 120. In other embodiments, however, pedestal 120 may have more than two corner casting inserts 160 as needed. Corner casting inserts 160 may be coupled to pedestal 120 using any appropriate technique (e.g., welded onto pedestal 120 or fastened to pedestal 120 using fasteners such as bolts).

Pin locking system 130 is a system that is used to secure wind turbine blade fixture 110 to pedestal 120. Pin locking system 130 is shown in more detail in reference to corner casting pin lock 200 illustrated in FIG. 2. In addition to corner casting 140 and corner casting insert 160, some embodiments of pin locking system 130 include a corner casting pin lock 150 and a padlock 180. Corner casting pin lock 150, as described in more detail below, includes an engagement member (e.g., engagement member 210) that is inserted through a first side aperture 145A of corner casting 140 and into corner casting insert 160. Once the engagement member of corner casting pin lock 150 is inserted into corner casting insert 160, one end of a detachable locking member of corner casting pin lock 150 (e.g., detachable locking member 230) may then be coupled to a second side aperture 145B of corner casting 140 (e.g., using hook 232). An opposite end of the detachable locking member may be inserted through an aperture of the handle (e.g., locking member aperture 225). The end of the detachable locking member that is inserted through the handle includes a padlock aperture (e.g., padlock aperture 234). A padlock 180 may then be installed through the padlock aperture of the detachable locking member in order to prevent corner casting pin lock 150 from being removed or becoming dislodged during transport. A particular embodiment of corner casting pin lock 150 is illustrated and described below in reference to FIG. 2.

Corner casting 140 is a hollow, cube-shaped structural object that is configured to couple to corner casting insert 160. In some embodiments, corner castings 140 are standard corner castings (e.g., ISO 1161 corner castings with dimensions of 178 mm×162 mm×118 mm) that are installed on the corners of shipping containers. In some embodiments, corner castings 140 are made of metal (e.g., cast steel). Each corner casting 140 includes an aperture on the top/bottom surface that allows at least a portion of corner casting insert 160 to be inserted into corner casting 140. In addition, each corner casting 140 includes at least two side apertures 145 as illustrated (e.g., a first side aperture 145A and a second side aperture 145B). In some embodiments, side apertures 145A and 145B are on adjacent sides of corner casting 140 (e.g., on adjacent sides of corner casting 140 that are orthogonal to each other). Side apertures 145 may have any appropriate shape and have any appropriate dimensions to enable the operation of corner casting pin lock 150 as described herein. In some embodiments, side apertures 145A-B each have a stadium shape (also known as a pill shape or a discorectangle shape).

Corner casting pin lock 150 is a device that is configured to be at least partially inserted through first side aperture 145A of corner casting 140 and at least partially through pin lock aperture 165 of corner casting insert 160 in order to secure wind turbine blade fixture 110 to pedestal 120. In general, corner casting pin lock 150 replaces devices such as twist locks that are typically used to secure corner castings 140 during transport. Twist locks have internal mechanisms (e.g., springs, etc.) that are prone to damage from certain forces (e.g., lateral and longitudinal forces) that are present when transporting large objects such as wind turbine blade 115. Corner casting pin lock 150, however, is a solid metal object (e.g., steel) that is more capable of handling the lateral and longitudinal forces from transporting objects such as wind turbine blade 115. A certain embodiment of corner casting pin lock 150 is discussed in more detail below in reference to FIG. 2.

FIG. 2 is a diagram illustrating a corner casting pin lock 200 that may be used as corner casting pin lock 150 by wind turbine blade transport system 100 of FIGS. 1A and 1B, according to particular embodiments. In some embodiments, corner casting pin lock 200 includes an engagement member 210, a handle 220, and a detachable locking member 230. In general, engagement member 210 is inserted into pin lock aperture 165 of corner casting insert 160 to secure corner casting 140 to corner casting insert 160. Handle 220 is used to insert engagement member 210 into corner casting insert 160 and to removably couple to detachable locking member 230. Detachable locking member 230 couples to corner casting 140 (e.g., via hook 232) and may be inserted into locking member aperture 225 of handle 220. Detachable locking member 230 may be padlocked to handle 220 using padlock 180 and padlock aperture 234 of detachable locking member 230.

In some embodiments, engagement member 210 has a shape of an elongated cylinder, as illustrated. In some embodiments, engagement member 210 has an end 214 that is opposite handle 220. In some embodiments, end 214 may have any appropriate shape. For example, end 214 may be rounded, pointed, or flat. In some embodiments, end 214 has a chamfered edge 216, as illustrated.

In some embodiments, engagement member 210 includes a diameter 212 that is smaller than a diameter of pin lock aperture 165 of corner casting insert 160 such that engagement member 210 contacts corner casting insert 160 as engagement member 210 is inserted through pin lock aperture 165. In some embodiments, diameter 212 is sized in order to prevent shearing of engagement member 210. For example, diameter 212 may be sized in order to prevent shearing based on the weight of wind turbine blade 115 or the transport vehicle (e.g., the railcar).

Handle 220 may have any appropriate shape that allows a user to insert engagement member 210 into corner casting insert 160. In some embodiments, handle 220 is a flat bar. Handle 220 may be coupled to engagement member 210 using any appropriate technique. For example, handle 220 may be welded to engagement member 210. In other embodiments, handle 220 may be removably coupled to engagement member 210 (e.g., using one or more fasteners such as bolts). In some embodiments, handle 220 is coupled to an end of engagement member 210 opposite end 214. In these embodiments, flat faces 227 of handle 220 are parallel to ends of engagement member 210 (e.g., end 214). In other embodiments, handle 220 is coupled to engagement member 210 at any appropriate angle.

In some embodiments, handle 220 includes a locking member aperture 225 that enables an end of detachable locking member 230 to be inserted into handle 220. Locking member 225 may have any appropriate shape (e.g., rectangular, square, stadium, etc.) and may have any appropriate dimensions that correspond to the shape of detachable locking member 230 and allow one end of detachable locking member 230 to be inserted into or through locking member aperture 225. In general, locking member aperture 225 is located proximate a distal end 222 of handle 220 that is opposite engagement member 210 (i.e., opposite engagement member end 221). In some embodiments, locking member aperture 225 is located a predetermined distance 226 from engagement member 210. Distance 226 may be any appropriate distance to enable detachable locking member 230 to be inserted into handle 220 while also coupling (e.g., via hook 232) to second side aperture 145B (i.e., based on dimensions of corner casting 140 and locations/sizes of side apertures 145).

In general, detachable locking member 230 provides a mechanism to prevent corner casting pin lock 200 from being removed or from becoming dislodged from corner casting insert 160 after engagement member 210 of corner casting pin lock 200 has been inserted into pin lock aperture 165. In some embodiments, detachable locking member 230 is a flat bar with flat faces 237. In some embodiments, flat faces 237 of detachable locking member 230 are orthogonal to flat faces 227 of handle 220 when an end of detachable locking member 230 (i.e., end 231 with padlock aperture 234) is at least partially inserted into locking member aperture 225 of handle 220. In some embodiments, detachable locking member 230 extends parallel to engagement member 210 when an end of detachable locking member 230 (i.e., end 231 with padlock aperture 234) is at least partially inserted into locking member aperture 225 of handle 220.

In some embodiments, detachable locking member 230 includes a hook 232 for removably coupling detachable locking member 230 to corner casting 140 via second side aperture 145B. In some embodiments, hook 232 is a J-shaped metal rod that is either permanently coupled to detachable locking member 230 (e.g., via welding) or removably coupled to detachable locking member 230 using one or more fasteners (e.g., bolts). In some embodiments, hook 232 is coupled to detachable locking member 230 proximate to end 233 of detachable locking member 230 (i.e., opposite end 231 and padlock aperture 234).

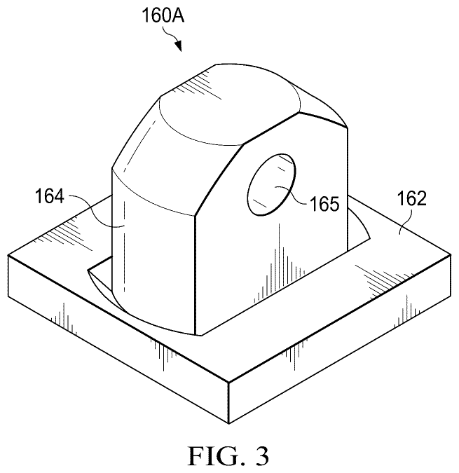

Corner casting insert 160 is a structural object that is configured to be at least partially inserted into corner casting 140 (e.g., corner casting 140 of wind turbine blade fixture 110). In general, corner casting insert 160 is the main structural object that is used along with corner casting pin lock 150 to secure corner casting 140. In some embodiments, corner casting insert 160 is formed from metal (e.g., steel). A particular embodiment of corner casting insert 160 is shown in more detail in FIG. 3.

As illustrated in FIG. 3, some embodiments of corner casting insert 160 include a base 162, a protrusion 164, and a pin lock aperture 165. In some embodiments, base 162 is square or rectangular in shape as illustrated and is used to secure corner casting insert 160 (e.g., via welding) to another object such as pedestal 120. Protrusion 164 may have any appropriate shape and dimensions that correspond to the inner chamber of corner casting 140. In some embodiments, for example, protrusion 164 may be tubular in shape except with two opposite flat sides as illustrated. In addition, protrusion 164 may have a chamfered top edge as illustrated. Pin lock aperture 165 is an aperture within protrusion 164 for engagement member 210 of corner casting pin lock 150. In some embodiments, pin lock aperture 165 is cylindrical in shape as illustrated and has a diameter that is slightly larger than engagement member 210 of corner casting pin lock 150.

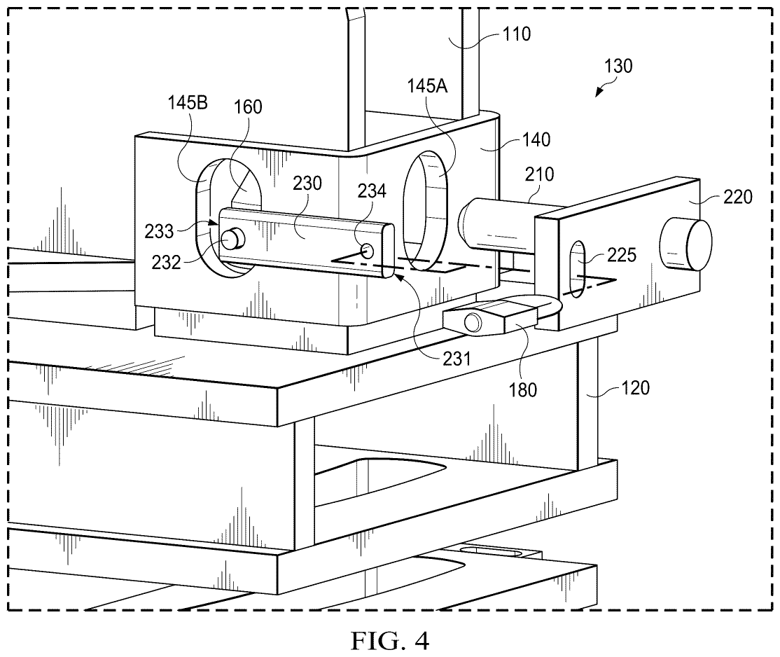

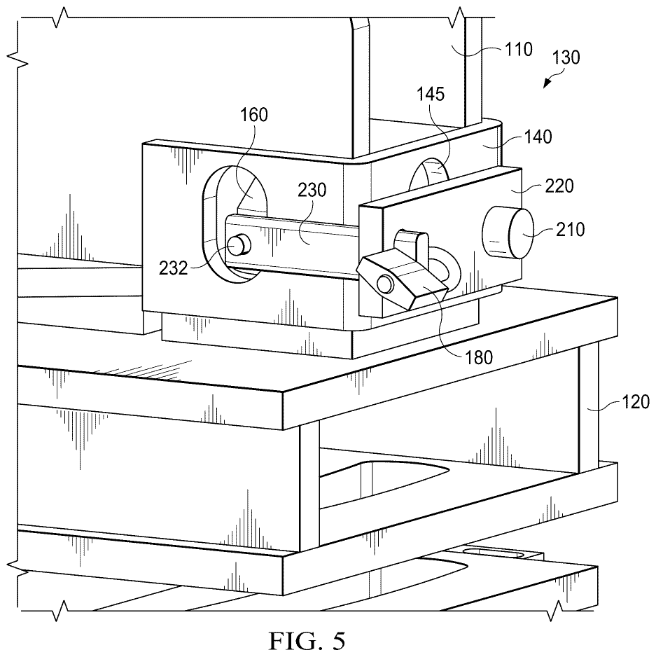

In operation, and in reference to FIGS. 4 and 5, pin locking system 130 may be used to secure corner casting 140 to corner casting insert 160 (e.g., in order to secure wind turbine blade fixture 110 to pedestal 120 as illustrated in FIGS. 1A and 1B). First, corner casting 140 is installed onto corner casting insert 160 such that protrusion 164 is within corner casting 140. Once corner casting 140 has been installed onto corner casting insert 160, corner casting pin lock 150 (e.g., corner casting pin lock 200 as illustrated in FIG. 2) is used to secure corner casting 140 to corner casting insert 160. First, one end of detachable locking member 230 of corner casting pin lock 150 (e.g., end 233) may be coupled to a second side aperture 145B of corner casting 140 (e.g., using hook 232). Next, engagement member 210 of corner casting pin lock 150 is inserted through first side aperture 145A of corner casting 140 and into pin lock aperture 165 of corner casting insert 160. FIG. 4 illustrates engagement member 210 being aligned with first side aperture 145A just prior to engagement member 210 being inserted into pin lock aperture 165. An opposite end of detachable locking member 230 (e.g., end 231) may be inserted through locking member aperture 225 of handle 220 such that padlock aperture 234 of detachable locking member 230 is located on an opposite side of handle 220 from corner casting 140. FIG. 5 illustrates pin locking system 130 after end 231 detachable locking member 230 has been inserted through locking member aperture 225 of handle 220 (i.e., a locking position). A padlock 180 may then be installed through padlock aperture 234 of detachable locking member 230 in order to prevent corner casting pin lock 150 from being removed or becoming dislodged during transport. As a result, corner casting 140 may be securely and efficiently locked to corner casting insert 160, thereby ensuring the safe transport of objects such as wind turbine blade 115.

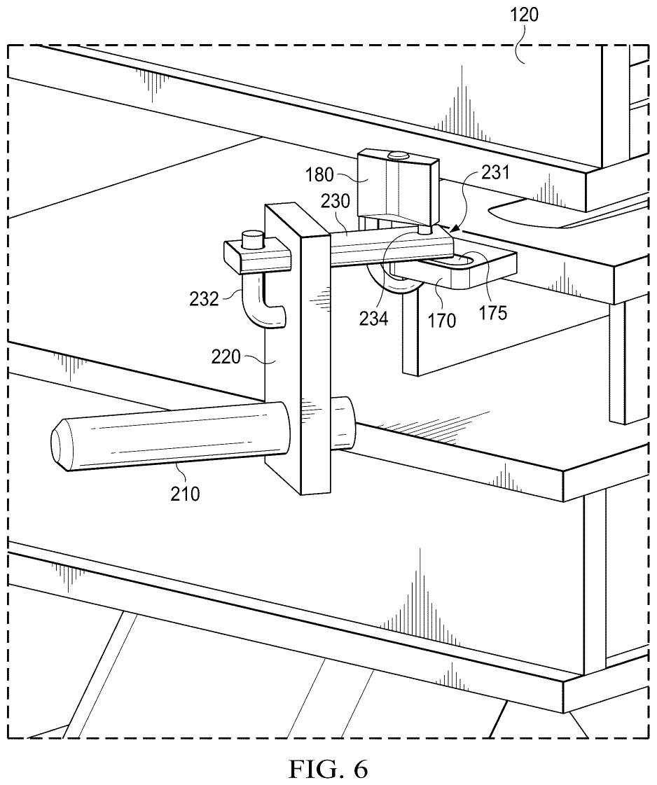

FIG. 6 is a diagram illustrating a storage position of corner casting pin lock 200 with a detachable locking member 230, according to particular embodiments. In these embodiments, a locking tab 170 may be welded or otherwise secured to any appropriate location (e.g., on pedestal 120). Locking tab 170, in some embodiments, is a structural component that is used to lock corner casting pin lock 200 to pedestal 120 using padlock 180 for storage. In some embodiments, locking tab 170 is a flat bar. Locking tab 170 includes a tab aperture 175 that is used to secure corner casting pin lock 150 using padlock 180. Tab aperture 175 may be any appropriate shape and dimensions in order to permit the operation of padlock 180. To securely store corner casting pin lock 200, end 231 of detachable locking member 230 is inserted through locking member aperture 225 of handle. Padlock 180 may then be installed through tab aperture 175 of locking tab 170 and padlock aperture 234 of detachable locking member 230. Padlock 180 secures detachable locking member 230 to locking tab 170, and hook 232 secures detachable locking member 230 to handle 220, thereby securely storing corner casting pin lock 200.

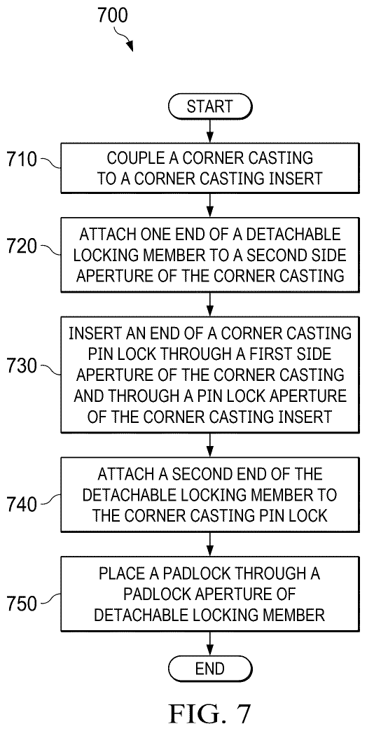

FIG. 7 is a chart illustrating a method 700 for securing corner castings using a corner casting pin lock device, according to particular embodiments. At step 710, a corner casting is coupled to a corner casting insert. In some embodiments, the corner casting is corner casting 140. In some embodiments, the corner casting insert is corner casting insert 160. In some embodiments, the corner casting is placed over the corner casting insert such that a protrusion of the corner casting insert (e.g., protrusion 164) is within the corner casting.

At step 720, one end of a detachable locking member is attached to a second side aperture of the corner casting. In some embodiments, the second side aperture of the corner casting is second side aperture 145B that is on a side of the corner casting that is adjacent to a first side aperture (e.g., first side aperture 145A). In some embodiments, the detachable locking member is detachable locking member 230. In some embodiments, the end of the detachable locking member that is attached to the second side aperture of the corner casting is end 233. In some embodiments, a hook (e.g., hook 232) coupled proximate to end 233 of detachable locking member 230 is attached to the second side aperture of the corner casting.

At step 730, an end of a corner casting pin lock is inserted through a first side aperture of the corner casting and through a pin lock aperture of the corner casting insert. In some embodiments, the corner casting pin lock is corner casting pin lock 150 (e.g., corner casting pin lock 200 as illustrated in FIG. 2). In some embodiments, the end of the corner casting pin lock is end 214 of engagement member 210. In some embodiments, the first side aperture of the corner casting is first side aperture 145A. In some embodiments, the pin lock aperture is pin lock aperture 165.

At step 740, a second end of the detachable locking member is attached to the corner casting pin lock. In some embodiments, the second end is end 231 of detachable locking member 230. In some embodiments, the second end is attached to the corner casting pin lock by inserting the second end of the detachable locking member through a locking member aperture of a handle of the corner casting pin lock. In some embodiments, the handle is handle 220 of corner casting pin lock 200, and the locking member aperture is locking member aperture 225. In some embodiments, step 740 includes inserting the second end of the detachable locking member through the locking member aperture of the handle of the corner casting pin lock until a padlock aperture (e.g., padlock aperture 234) is on an opposite side of the handle from the corner casting.

At step 750, a padlock is placed through the padlock aperture of the detachable locking member 230. In some embodiments, the padlock aperture is padlock aperture 234 that is proximate end 231 of detachable locking member 230. In some embodiments, the padlock is padlock 180. After step 750, method 700 may end.

Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method including the particular steps of the method of FIG. 7, this disclosure contemplates any suitable method including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

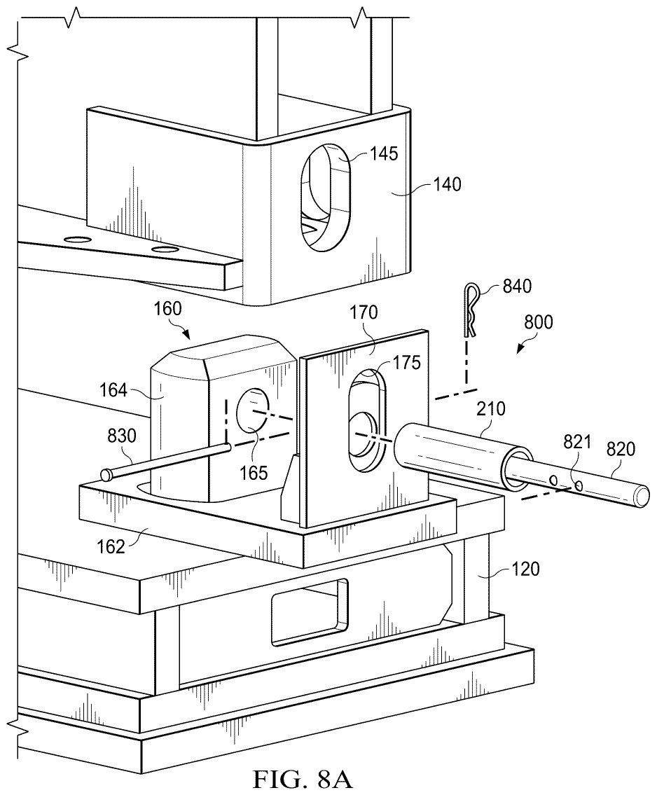

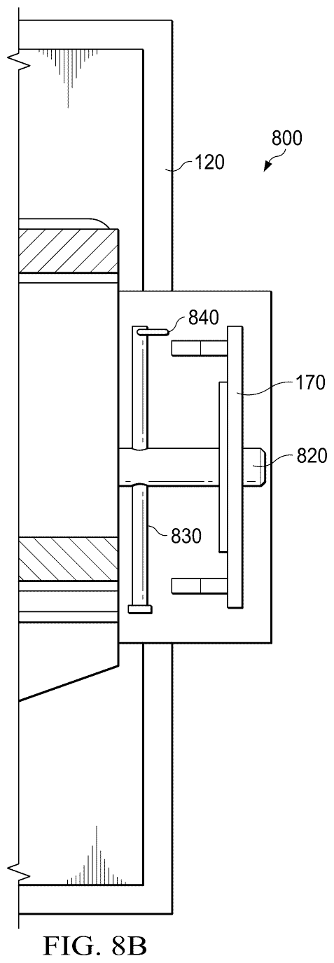

FIGS. 8A and 8B are diagrams illustrating a corner casting pin lock 800 that may be used as corner casting pin lock 150 by wind turbine blade transport system 100 of FIGS. 1A and 1B, according to particular embodiments. FIG. 8A illustrates a perspective view of corner casting pin lock 800, and FIG. 8B illustrate a top-down view of corner casting pin lock 800. In some embodiments, corner casting pin lock 800 includes engagement member 210, a handle 820, and a detachable locking member 830. In general, engagement member 210 is inserted through tab aperture 175 of locking tab 170 and into pin lock aperture 165 of corner casting insert 160 in order to secure corner casting 140 to corner casting insert 160. Handle 820 is used to insert engagement member 810 into corner casting insert 160 and to removably couple to detachable locking member 830. Detachable locking member 830 couples to handle 820 and is secured in place with a cotter pin 840.

Handle 820 may have any appropriate shape that allows a user to insert engagement member 210 into corner casting insert 160. In some embodiments, handle 820 is a straight rod as illustrated, but may have any other appropriate shape or dimensions. Handle 820 may be coupled to engagement member 210 using any appropriate technique. For example, handle 820 may be welded to engagement member 210. In other embodiments, handle 820 may be removably coupled to engagement member 210 (e.g., using one or more fasteners such as bolts).

In some embodiments, handle 820 includes one or more locking member apertures 821 that enable an end of detachable locking member 830 to be inserted through handle 820. In general, locking member apertures 821 are located at positions along handle 820 that are located between corner casting insert 160 and locking tab 170 when engagement member 210 is fully inserted into corner casting insert 160.

In general, detachable locking member 830 provides a mechanism to prevent corner casting pin lock 800 from being removed or from becoming dislodged from corner casting insert 160 after engagement member 210 of corner casting pin lock 800 has been inserted into pin lock aperture 165. In some embodiments, detachable locking member 830 is a rod or pin. In some embodiments, detachable locking member 830 includes an aperture that enables cotter pin 840 to be inserted into detachable locking member 830, thereby preventing detachable locking member 830 from being removed. Detachable locking member 830 sits between corner casting insert 160 and locking tab 170 when installed through handle 820.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “member,” “module,” “device,” “unit,” “component,” “element,” “mechanism,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

While the include figures illustrate particular embodiments having particular components, this disclosure contemplates other embodiments having some or all of the described components, as well as additional components not described. Components of the present disclosure may be any suitable shape and may be in any suitable configuration.

As used in this document, “each” refers to each member of a set or each member of a subset of a set. Furthermore, as used in the document “or” is not necessarily exclusive and, unless expressly indicated otherwise, can be inclusive in certain embodiments and can be understood to mean “and/or.” Similarly, as used in this document “and” is not necessarily inclusive and, unless expressly indicated otherwise, can be inclusive in certain embodiments and can be understood to mean “and/or.”

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosures can be established by the appended claims rather than by the foregoing description. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

1. A wind turbine blade transport system comprising:
a turbine blade fixture configured to secure one end of a turbine blade, the turbine blade fixture comprising a corner casting, the corner casting comprising a first side aperture and a second side aperture;
a pedestal configured to removably couple to the turbine blade fixture, the pedestal comprising a corner casting insert configured to be at least partially inserted into the corner casting of the turbine blade fixture as the turbine blade fixture is lowered onto the pedestal, the corner casting insert comprising a pin lock aperture; and
a corner casting pin lock comprising:
an engagement member configured to be inserted through the first side aperture of the corner casting and at least partially through the pin lock aperture of the corner casting insert;
a handle coupled to the engagement member and comprising a locking member aperture on a distal end of the handle opposite the engagement member; and
a detachable locking member configured to be at least partially inserted into the locking member aperture of the handle, the detachable locking member comprising:
a hook configured to couple the detachable locking member to the corner casting through the second side aperture; and
a padlock aperture proximate an opposite end of the detachable locking member from the hook.

2. The wind turbine blade transport system of claim 1, wherein:
the engagement member of the corner casting pin lock has a shape of an elongated cylinder;
the pin lock aperture of the corner casting insert is cylindrical in shape; and
the engagement member comprises a diameter that is smaller than a diameter of the pin lock aperture such that the engagement member contacts the corner casting insert as the engagement member is inserted through the pin lock aperture.

3. The wind turbine blade transport system of claim 2, wherein the diameter of the engagement member is sized in order to prevent shearing of the engagement member when the turbine blade is lifted.

4. The wind turbine blade transport system of claim 1, wherein:
the engagement member of the corner casting pin lock has a shape of an elongated cylinder;
an end of the engagement member that is opposite the handle comprises a chamfered edge; and
the handle is a flat bar.

5. The wind turbine blade transport system of claim 1, wherein:
the handle is a flat bar;
the detachable locking member is a flat bar; and
flat faces of the handle are orthogonal to flat faces of the detachable locking member when the detachable locking member is at least partially inserted into the locking member aperture of the handle.

6. The wind turbine blade transport system of claim 1, wherein the detachable locking member extends parallel to the engagement member when the detachable locking member is at least partially inserted into the locking member aperture of the handle.

7. The wind turbine blade transport system of claim 1, wherein a distance between the engagement member and the locking member aperture of the handle is based on dimensions of the corner casting.

8. A corner casting pin locking system comprising:
a corner casting comprising a first side aperture and a second side aperture;
a corner casting insert configured to be at least partially inserted into the corner casting, the corner casting insert comprising a pin lock aperture; and
a corner casting pin lock comprising:
an engagement member configured to be inserted through the first side aperture of the corner casting and at least partially through the pin lock aperture of the corner casting insert;
a handle coupled to the engagement member and comprising a locking member aperture on a distal end of the handle opposite the engagement member; and
a detachable locking member configured to be at least partially inserted into the locking member aperture of the handle, the detachable locking member comprising:
a hook configured to couple the detachable locking member to the corner casting through the second side aperture; and
a padlock aperture proximate an opposite end of the detachable locking member from the hook.

9. The corner casting pin locking system of claim 8, wherein:
the engagement member of the corner casting pin lock has a shape of an elongated cylinder;
the pin lock aperture of the corner casting insert is cylindrical in shape; and
the engagement member comprises a diameter that is smaller than a diameter of the pin lock aperture such that the engagement member contacts the corner casting insert as the engagement member is inserted through the pin lock aperture.

10. The corner casting pin locking system of claim 9, wherein the diameter of the engagement member is sized in order to prevent shearing of the engagement member.

11. The corner casting pin locking system of claim 8, wherein:
the engagement member of the corner casting pin lock has a shape of an elongated cylinder;
an end of the engagement member that is opposite the handle comprises a chamfered edge; and
the handle is a flat bar.

12. The corner casting pin locking system of claim 8, wherein:
the handle is a flat bar;
the detachable locking member is a flat bar; and
flat faces of the handle are orthogonal to flat faces of the detachable locking member when the detachable locking member is at least partially inserted into the locking member aperture of the handle.

13. The corner casting pin locking system of claim 8, wherein the detachable locking member extends parallel to the engagement member when the detachable locking member is at least partially inserted into the locking member aperture of the handle.

14. The corner casting pin locking system of claim 8, wherein a distance between the engagement member and the locking member aperture of the handle is based on dimensions of the corner casting.

15. A corner casting pin lock comprising:
an engagement member configured to be inserted through a first side aperture of a corner casting and at least partially through a pin lock aperture of a corner casting insert;
a handle coupled to the engagement member and comprising a locking member aperture on a distal end of the handle opposite the engagement member; and
a detachable locking member configured to be at least partially inserted into the locking member aperture of the handle, the detachable locking member comprising:
a hook configured to couple the detachable locking member to the corner casting through a second side aperture of the corner casting; and
a padlock aperture proximate an opposite end of the detachable locking member from the hook.

16. The corner casting pin lock of claim 15, wherein:
the engagement member of the corner casting pin lock has a shape of an elongated cylinder;
the pin lock aperture of the corner casting insert is cylindrical in shape; and
the engagement member comprises a diameter that is smaller than a diameter of the pin lock aperture such that the engagement member contacts the corner casting insert as the engagement member is inserted through the pin lock aperture.

17. The corner casting pin lock of claim 16, wherein the diameter of the engagement member is sized in order to prevent shearing of the engagement member.

18. The corner casting pin lock of claim 15, wherein:
the engagement member of the corner casting pin lock has a shape of an elongated cylinder;
an end of the engagement member that is opposite the handle comprises a chamfered edge; and
the handle is a flat bar.

19. The corner casting pin lock of claim 15, wherein the detachable locking member extends parallel to the engagement member when the detachable locking member is at least partially inserted into the locking member aperture of the handle.

20. The corner casting pin lock of claim 15, wherein a distance between the engagement member and the locking member aperture of the handle is based on dimensions of the corner casting.
